(19) United States
(12) Patent Application Publication
(10) Pub. No.: US 2021/0123769 A1
(43) Pub. Date: Apr. 29, 2021

(54) METHOD AND DEVICE FOR CONTROLLING A MAPPING METHOD

(71) Applicant: Robert Bosch GmbH, Stuttgart (DE)

(72) Inventors: Carsten Hasberg, Ilsfeld-Auenstein (DE); Leonie Sautter, Ludwigsburg (DE); Philipp Klippel, Erdmannhausen (DE); Valentin Frommherz, Heilbronn (DE)

(21) Appl. No.: 17/077,285

(22) Filed: Oct. 22, 2020

(30) Foreign Application Priority Data
Oct. 29, 2019 (DE) 102019216671.7

(51) Int. Cl. G01C 21/00; B60W 60/00

(52) U.S. Cl. CPC G01C 21/3837; B60W 2556/50; B60W 60/0027

(57) ABSTRACT

A method and a device for controlling a mapping method. The method includes a step of detecting a position of a mapping vehicle, a step of detecting vehicle data values as a function of the position, the vehicle data values representing vehicles in surroundings of the mapping vehicle, a step of determining a quality of the surroundings for the mapping method as a function of the vehicles in the surroundings, and a step of providing a signal for controlling the mapping method as a function of the quality.

### CROSS REFERENCE

The present application claims the benefit under 35 U.S.C. § 119 of German Patent Application No. DE 102019216671.7 filed on Oct. 29, 2019, which is expressly incorporated herein by reference in its entirety.

### FIELD

The present invention relates, among other things, to a method for controlling a mapping method, as a function of a quality, this quality being determined as a function of vehicles in surroundings of a mapping vehicle.

### BACKGROUND INFORMATION

Highly automatic vehicles need a highly precise localization. Localization methods which are based on the detection of features (here: surroundings features)—a so-called feature localization—are available in the related art.

For this purpose, maps of these features are created from one or multiple measuring trip(s). In the localization vehicle, the localization map features are compared to instantaneously measured or detected sensor features to determine the vehicle position and orientation, relative to this map.

A conventional problem for mapping methods is that, for example, a large number of parked vehicles or dense traffic may both, on the one hand, conceal these features and, on the other hand, be erroneously included in the map. In addition, certain weather conditions (e.g., heavy rain or snowfall) are disadvantageous for the quality of the map, depending on the type of sensors, since the other vehicles may also conceal features in the surroundings.

### SUMMARY

A method according to an example embodiment of the present invention for controlling a mapping method includes a step of detecting a position of a mapping vehicle, and a step of detecting vehicle data values as a function of the position, the vehicle data values representing vehicles in surroundings of the mapping vehicle. The method furthermore includes a step of determining a quality of the surroundings for the mapping method as a function of the vehicles in the surroundings, and a step of providing a signal for controlling the mapping method as a function of the quality.

A mapping method shall be understood to mean a method for creating a (digital) map and/or for expanding or supplementing an existing map.

A mapping vehicle shall be understood to mean a vehicle which includes a surroundings sensor system, the surroundings sensor system including at least one video sensor and/or at least one radar sensor and/or at least one LIDAR sensor and/or at least one ultrasonic sensor and/or at least one further sensor, which is designed to detect surroundings of the vehicle in the form of surroundings data values. The surroundings sensor system is, in particular, designed to detect features in the surroundings (course of a road, traffic signs, roadway marking, buildings, roadway boundaries, etc.), these surroundings features being used (usable) for the mapping method. In one specific embodiment, the surroundings sensor system includes, for example, a processing unit (processor, working memory, hard disk) including suitable software and/or is connected to such a processing unit, by which it is possible to detect and/or classify or assign these surroundings features.

A detection of vehicle data values shall, for example, be understood to mean the requesting and/or receiving of the vehicle data values from an external server or a cloud and/or a memory unit, which encompasses the vehicle data values.

A quality of the surroundings for the mapping method shall, for example, be understood to mean how suitable the surroundings are for the mapping method, at least temporarily (at least for the duration during which the mapping vehicle is situated in an area of the surroundings). For example, surroundings are not suitable when surroundings features, in particular static surroundings features, relevant for the mapping process, cannot be detected or cannot be detected reliably or precisely, due to certain circumstances (based on the surroundings sensor system of the mapping vehicle). Accordingly, surroundings are suitable, or the quality is accordingly high, when these relevant surroundings features may be detected with the aid of the surroundings sensor system of the mapping vehicle. The quality is, for example, a digital value between 0 and 1 (0: poor, not suitable, etc.; 1: good, suitable, etc.; values in between (0.3, 0.5, etc.) represent intermediate stages which represent, for example, that only individual surroundings features may be detected, or that detected surroundings features may only be detected partially or with a corresponding error tolerance.

The example method according to the present invention advantageously, among other things, may achieve the object of controlling a mapping method in such a way that both a mapping complexity and also mapping costs are reduced. This object is achieved with the aid of the method according to the present invention in that, on the one hand, a quality of the surroundings for the mapping method is determined at least as a function of vehicles in the surroundings, and, on the other hand, a signal for controlling the mapping method is provided as a function of the previously determined quality. In this way, for example, fewer mapping trips are required since these may be carried out in a targeted manner, as a function of the quality. Furthermore, costs for data transmissions, which are necessary for the mapping method, may be reduced in that, for example, mapping data transmissions are only used, as a function of the quality, when they may also be used for the mapping method due to their quality.

The signal preferably represents a request for transmitting surroundings data values, the surroundings data values representing the surroundings of the mapping vehicle, the surroundings encompassing at least one surroundings feature for the mapping method.

A request for transmitting surroundings data values shall, for example, be understood to mean that the mapping vehicle, on its own, prompts a transmission of the surroundings data values to a mapping server in that a transceiver unit of the mapping vehicle is prompted, with the aid of the signal, to accordingly transmit or emit the surroundings data values. In an alternative specific embodiment, it shall be understood to mean that a mapping server provides the signal in such a way, or emits the signal to the mapping vehicle with the aid of a transceiver unit in such a way, that the mapping vehicle receives a corresponding request, in the form of the signal, for transmitting the surroundings data values.

The vehicle data values preferably represent parked vehicles and/or stationary vehicles in the surroundings of the mapping vehicle. Preferably, furthermore weather data which represent a weather condition in the surroundings are detected, the quality of the surroundings for the mapping method additionally taking place as a function of the weather condition in the surroundings.

The determination of the quality as a function of the vehicles in the surroundings (parked and/or stationary vehicles), etc.) and/or additionally as a function of the weather condition in the surroundings, takes place, for example, in that the quality is determined as a function of the aforementioned parameters. In one further specific embodiment, the determination of the quality takes place, for example, with the aid of a (digital) value matrix in that different combinations of the aforementioned parameters (number of parked and/or stationary vehicles and/or different weather conditions (sunny, foggy, light rain, heavy rain, snowfall, etc.)) are assigned corresponding quality values.

This yields the advantages that in particular vehicles which (may) conceal features in the surroundings relevant for the mapping method, as well as certain weather conditions which (may) severely impair a functional capability of a sensor, are taken into consideration so that, for example, expensive data transmissions of the surroundings data values which, in some circumstances, offer no or only very little benefit for the desired mapping method, are avoided.

The signal preferably encompasses a vehicle strategy for operating the mapping vehicle, the vehicle strategy providing an at least partial drive through the surroundings for the mapping method.

This shall be understood to mean, for example, that the vehicle strategy represents a specification for a trip, for example with the aid of individual coordinates and/or with the aid of a predefined trajectory and/or with the aid of commands for an automated transverse and longitudinal control of the mapping vehicle, etc., which is transmitted to the mapping vehicle in the form of the signal.

This may yield the advantage that, as a function of the quality of the surroundings, a mapping trip is carried out in a targeted manner in these surroundings when, corresponding to the quality, the condition of the surroundings is favorable for the mapping method (few parked vehicles, good, weather-related, “visibility conditions” for the surroundings sensor system, etc.). This reduces costs for a mapping trip, for example, in that this mapping trip only takes place when the surroundings data values detected in the process offer a corresponding benefit for the mapping method.

A device according to an example embodiment of the present invention, in particular, a control unit or a mapping server, is configured to carry out all steps of the example methods described herein.

In one possible specific embodiment of the present invention, the device includes a processing unit (processor, working memory, hard disk) as well as suitable software for carrying out the example methods described herein. For this purpose, the device includes, for example, a transceiver unit, which is designed to provide and/or to transmit and/or to receive a position (in the form of data values) and/or vehicle data values and/or surroundings data values and/or a signal for controlling the mapping vehicle. In one alternative specific embodiment, the device is connected to a transceiver unit with the aid of a suitable interface.

A mapping server shall, for example, be understood to mean a server or a combination of servers (cloud) which is configured to carry out a mapping method. In one possible specific embodiment, the device is designed as a control unit of the mapping vehicle, which is able to exchange data values or (digital) signals with a mapping server with the aid of a transceiver unit, the method, however, being carried out on the part of the mapping vehicle. In one alternative specific embodiment, the device itself corresponds to a mapping server, or is encompassed by a mapping method, the method being carried out on the part of the mapping server.

Furthermore, an example computer program is provided in accordance with the present invention, encompassing commands which, during the execution of the computer program by a computer, prompt the computer to carry out the example methods described herein. In one specific embodiment, the computer program corresponds to the software encompassed by the device.

Moreover, a machine-readable memory medium is provided, on which the computer program is stored.

Advantageous refinements of the present invention are described herein.

### BRIEF DESCRIPTION OF THE DRAWINGS

Exemplary embodiments of the present invention are shown in the figures and are described in greater detail below.

FIG. 1 shows an exemplary embodiment of the method according to the present invention, the device according to the present invention being designed as a control unit.

FIG. 2 shows an exemplary embodiment of the method according to the present invention, the device according to the present invention being designed as a mapping server.

FIG. 3 shows an exemplary embodiment of the method according to the present invention in the form of a flowchart.

### DETAILED DESCRIPTION OF EXAMPLE EMBODIMENTS

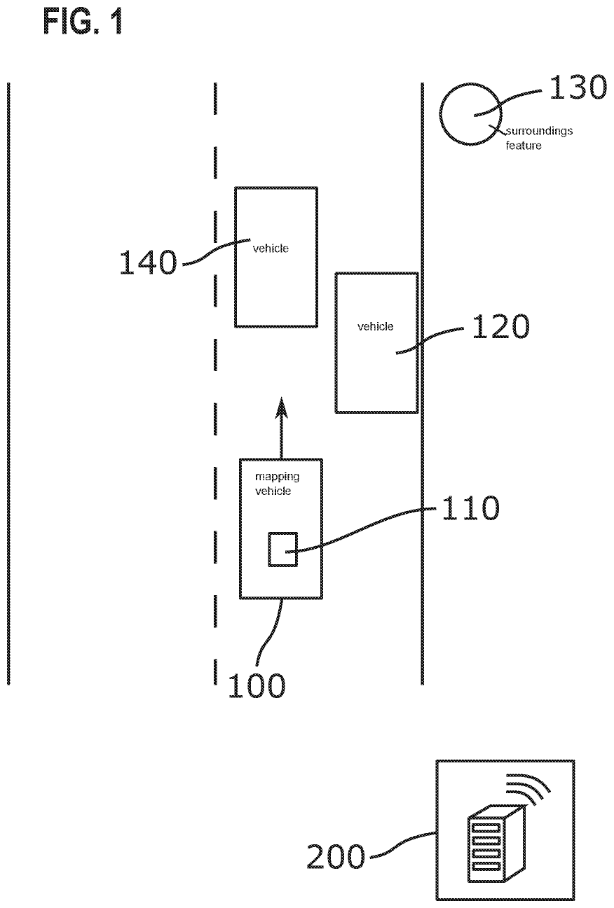

FIG. 1 shows a mapping vehicle 100, which is moving along a traffic route. A position of the mapping vehicle is detected in the process by being determined, for example, with the aid of a localization unit (navigation system, etc.). Thereafter, vehicle data values are detected, as a function of the position, the vehicle data values representing vehicles 120, 140 in surroundings of the mapping vehicle. In one specific embodiment, the vehicle data values represent, for example, parked vehicles 120 and/or stationary vehicles 140 and/or a traffic density (for example in the form of a corresponding value) in the surroundings of the mapping vehicle 100.

Thereafter, a quality of the surroundings for the mapping method is determined with the aid of device 110, at least as a function of vehicles 120, 140 in the surroundings. In one alternative specific embodiment, for example, furthermore weather data which represent a weather condition in the surroundings are detected. The determination of the quality of the surroundings for the mapping method additionally takes place as a function of the weather condition in the surroundings.

Thereafter, a signal for controlling the mapping method 100, as a function of the quality, is provided. In one specific embodiment, the signal is, for example, provided in such a way that surroundings data values, which represent the surroundings of mapping vehicle 100, are transmitted to a mapping server 200, the surroundings encompassing at least one surroundings feature 130 for the mapping method. In one alternative specific embodiment, the signal represents, for example, that, proceeding from the previously determined quality, no transmission takes place in that the method is aborted.

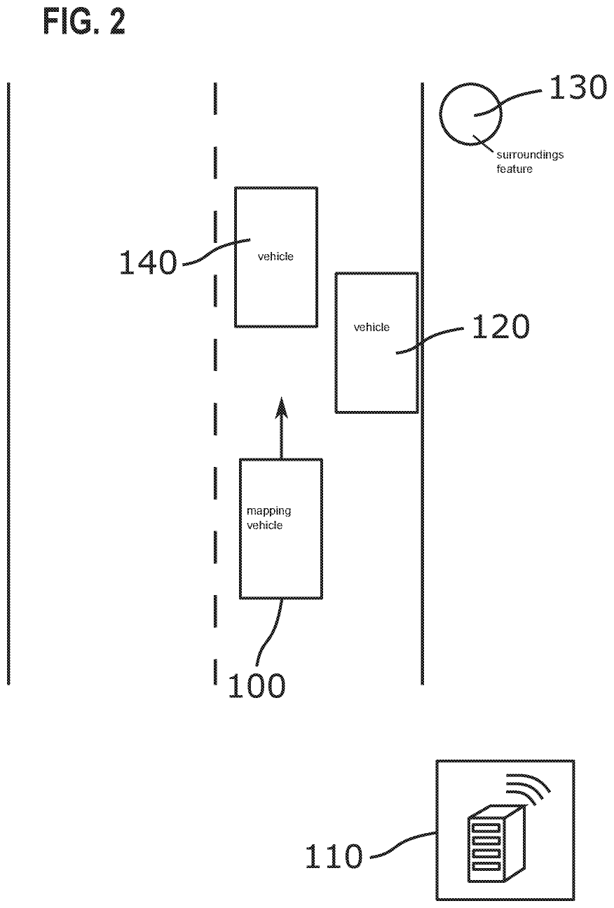

FIG. 2 shows a mapping vehicle 100, which is moving along a traffic route. A position of the mapping vehicle is detected in the process by, for example, being determined with the aid of a localization unit (navigation system, etc.), transmitted with the aid of a transceiver unit, and received by device 110. Thereafter, vehicle data values are detected, as a function of the position, the vehicle data values representing vehicles 120, 140 in surroundings of the mapping vehicle. In one specific embodiment, the vehicle data values represent, for example, parked vehicles 120 and/or stationary vehicles 140 and/or a traffic density (for example in the form of a corresponding value) in the surroundings of the mapping vehicle 100.

Thereafter, a quality of the surroundings for the mapping method is determined with the aid of device 110, at least as a function of vehicles 120, 140 in the surroundings. In one alternative specific embodiment, for example, furthermore weather data which represent a weather condition in the surroundings are detected. Determination 330 of the quality of the surroundings for the mapping method additionally takes place as a function of the weather condition in the surroundings. In one further specific embodiment, determination 330, in addition or as an alternative, takes place as a function of further vehicles which detect the surroundings in advance, independently of mapping vehicle 100, and transmit them to the mapping server (directly or with the aid of temporarily stored servers) and/or, in addition or as an alternative, as a function of external, relative to mapping vehicle 100, weather services.

Thereafter, a signal for controlling mapping method 300, as a function of the quality, is provided. In one specific embodiment, the signal is, for example, provided in such a way that the signal represents a request for transmitting surroundings data values, the surroundings data values representing the surroundings of mapping vehicle 100, the surroundings encompassing at least one surroundings feature 130 for the mapping method. In the process, the requested surroundings data values are already detected before the provision of the signal, for example in that mapping vehicle 100 (regularly) detects the surroundings anyhow, or they are only detected after the signal for the request was received by mapping vehicle 100 and accordingly evaluated or processed. In this possible specific embodiment, the signal thus, for example, represents a vehicle strategy for operating mapping vehicle 100, the vehicle strategy providing an at least partial drive through the surroundings for the mapping method. This has the advantage that mapping vehicle 100, as a function of its position, and as a function of the quality of the surroundings, is used by device 110 (here: mapping server) to detect these surroundings (or the at least one surroundings feature 130 encompassed by the surroundings) for the mapping method in the form of surroundings data values, and to transmit them to device 110.

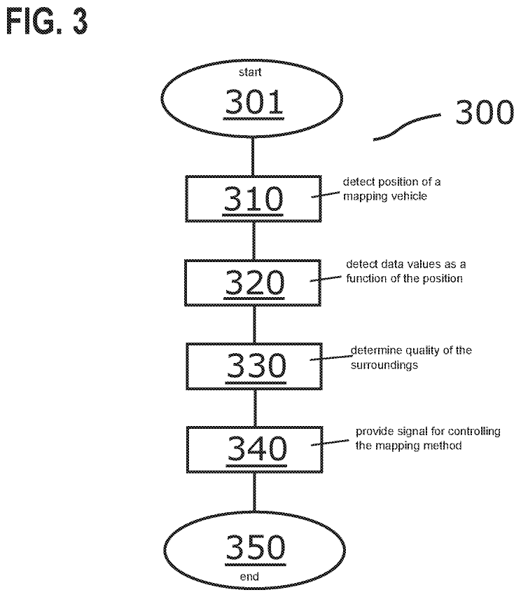

FIG. 3 shows one exemplary embodiment of a method 300 for controlling a mapping method.

In step 301, method 300 starts.

In step 310, a position of a mapping vehicle 100 is detected.

In step 320, vehicle data values are detected as a function of the position, the vehicle data values representing vehicles 120, 140 in surroundings of mapping vehicle 100.

In step 330, a quality of the surroundings for the mapping method is determined as a function of vehicles 120, 140 in the surroundings.

In step 340, a signal for controlling the mapping method, as a function of the quality, is provided.

In step 350, method 300 ends.

What is claimed is:

1. A method for controlling a mapping method, comprising the following steps:
detecting a position of a mapping vehicle;
detecting vehicle data values as a function of the position, the vehicle data values representing vehicles in surroundings of the mapping vehicle;
determining a quality of the surroundings for the mapping method, as a function of the vehicles in the surroundings; and
providing a signal for controlling the mapping method as a function of the quality.

2. The method as recited in claim 1, wherein the signal represents a request for transmitting surroundings data values, the surroundings data values representing the surroundings of the mapping vehicle, the surroundings including at least one surroundings feature for the mapping method.

3. The method as recited in claim 1, wherein the vehicle data values represent parked vehicles and/or stationary vehicles in the surroundings of the mapping vehicle.

4. The method as recited in claim 1, further comprising:
detecting weather data which represent a weather condition in the surroundings, the quality of the surroundings for the mapping method additionally resulting as a function of the weather condition in the surroundings.

5. The method as recited in claim 1, wherein the signal represents a vehicle strategy for operating the mapping vehicle, the vehicle strategy providing an at least partial drive through the surroundings for the mapping method.

6. A device configured to control a mapping method, the device configured to:
detect a position of a mapping vehicle;
detect vehicle data values as a function of the position, the vehicle data values representing vehicles in surroundings of the mapping vehicle;
determine a quality of the surroundings for the mapping method, as a function of the vehicles in the surroundings; and
provide a signal for controlling the mapping method as a function of the quality.

7. A non-transitory machine-readable memory medium on which is stored a computer program for controlling a mapping method, the computer program, when executed by a computer, causing the computer to perform the following steps:
detecting a position of a mapping vehicle;
detecting vehicle data values as a function of the position, the vehicle data values representing vehicles in surroundings of the mapping vehicle;
determining a quality of the surroundings for the mapping method, as a function of the vehicles in the surroundings; and
providing a signal for controlling the mapping method as a function of the quality.
